(19) United States
(12) Patent Application Publication
(10) Pub. No.: US 2011/0045872 A1
(43) Pub. Date: Feb. 24, 2011

(54) Portable Heads-Up Display System For Cellular Telephones

(76) Inventor: Craig L. Simmons, Woodland Hills, CA (US)

Correspondence Address: LATHROP & GAGE LLP, 4845 PEARL EAST CIRCLE, SUITE 201, BOULDER, CO, 80301, US

(21) Appl. No.: 12/850,297

(22) Filed: Aug. 4, 2010

Related U.S. Application Data
(63) Continuation-in-part of application No. 11/670,200, filed on Feb. 1, 2007.

(51) Int. Cl. H04B 1/38; G09G 5/00

(52) U.S. Cl. 455/557; 345/7

(57) ABSTRACT

A portable heads-up display system for a cellular telephone. The system includes a transparent display panel including a display for displaying information sent and received via the telephone, a display mount, removably attachable to a dashboard of a vehicle, a flexible gooseneck connecting the display panel and the display mount, and a keypad box, affixable to a steering wheel of the vehicle, including a keypad for entering telephone numbers to be dialed, wirelessly coupled between the telephone and the display.

### RELATED APPLICATIONS

This application is claims priority to and is a continuation-in-part of U.S. patent application Ser. No. 11/670,200, filed Feb. 1, 2007, the disclosure of which is incorporated herein by reference.

### BACKGROUND

It has become common to use cellular telephones in automobiles, while an automobile is being driven. Regardless of the type of cellular telephone being used, a driver generally views some type of display to dial a telephone number, or to see information concerning an incoming call, such as the caller ID. Most presently known in-vehicle display devices, including LCD panels and other types of monitors, require drivers to take their eyes off the road, which presents a safety hazard. Other in-vehicle display devices that appear as ‘heads-up’ displays require that the devices and support hardware be permanently installed in the vehicle. What is needed is a portable heads-up display system for a cellular telephone that can easily be installed in any particular vehicle, while being removable and transportable from one vehicle to another.

### SOLUTION TO THE PROBLEM

A system and method are disclosed for displaying cellular telephone-related information via a portable heads-up display in automobiles and other transportation vehicles.

The present system includes a transparent display connected to a flexible gooseneck with a mount removably affixable to the dashboard of a vehicle, and a keypad box for entering cell phone numbers to be dialed, affixed to the vehicle steering wheel. The keypad box wirelessly receives information from the cellular telephone and wirelessly transmits the information to the display.

### BRIEF DESCRIPTION OF THE DRAWINGS

FIG. 1A is a diagram showing a high-level view of one exemplary embodiment of the present system;

FIG. 1B is an exemplary diagram showing a high-level view of one alternative embodiment of the present system;

FIG. 2A is a diagram of an exemplary embodiment showing information displayable on a heads-up display in accordance with the present system;

FIG. 2B is a diagram of an exemplary embodiment showing a heads-up display in accordance with the present system;

FIG. 2C is a diagram of an exemplary alternative embodiment showing details of a wireless heads-up display assembly in accordance with the present system;

FIG. 3A is a diagram of an exemplary embodiment showing user input control mechanisms on the top side of a keypad/display control box;

FIG. 3B is a diagram of an exemplary embodiment showing details of a keypad/display control box using electrically-conducting media to provide communication between the control box and heads-up display;

FIG. 3C is a diagram of an exemplary embodiment showing details of a keypad/display control box using a wireless protocol to provide communication between the control box and heads-up display;

FIG. 4A is a diagram showing an exemplary heads-up display in one embodiment of the present system;

FIG. 4B is a diagram showing exemplary construction of an alternative embodiment of the present system in which an LCD display is employed; and

FIG. 4C is a diagram showing details of an exemplary construction of the display of FIG. 4B.

FIG. 5A is a diagram showing an exemplary configuration of a heads-up display system, in an alternative embodiment;

FIG. 5B is a diagram showing exemplary details of keypad 104A;

FIG. 5C is a diagram of an exemplary embodiment showing details of a keypad box using a wireless protocol to provide communication between a cellular phone and the heads-up display; and

FIG. 5D is a diagram of an embodiment showing exemplary methods for mounting the display on a vehicle dashboard.

### DETAILED DESCRIPTION

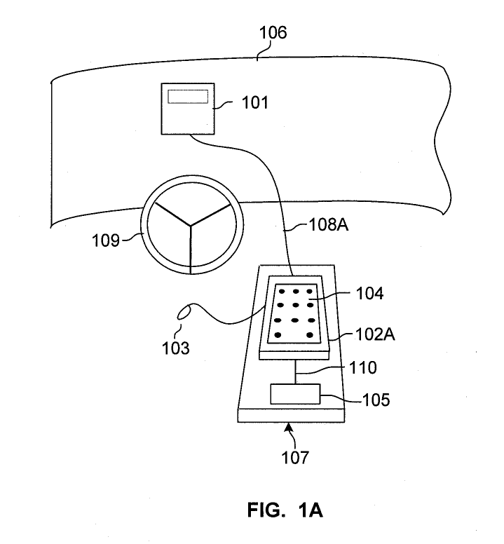

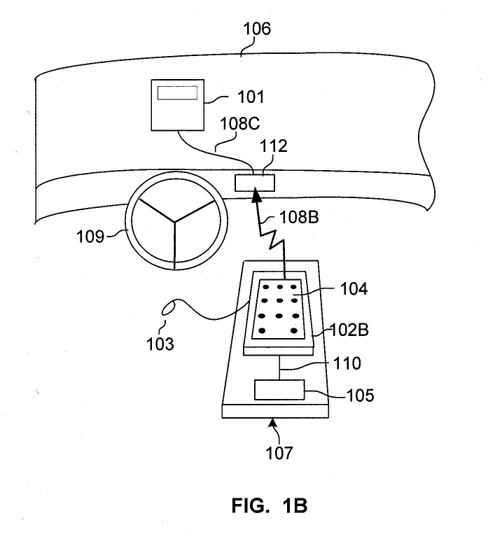

The present method employs existing technology to provide a portable heads-up display for cellular telephones used in automobiles and in other means of transportation. FIG. 1A is a diagram showing a high-level view of one exemplary embodiment of the present system. As shown in FIG. 1A, a heads-up display panel 101 (described in detail below) is removably affixed to a windshield 106 of an automobile or other vehicle. The heads-up display 101 is typically placed on the windshield at a driver's eye-level, which, in the case of an automobile, is directly above the steering wheel 109.

In the embodiment shown in FIG. 1A, heads-up display 101 is connected to a touch pad or keypad (hereinafter “keypad”) 104 (also described in detail below) via wiring 108A and touch-pad box 102A, which may be affixed, typically via temporary means such as Velcro®, double-sided clear tape, or temporary adhesive, to an armrest or console 107 or other part of the vehicle within reach of a driver's hand. Touch-pad box 102A is connected to a cellular telephone 105 via wiring 110, and also to an earphone or other audio transducer 103. Alternatively, display 101 may be temporarily affixed to the windshield using a transparent plastic plate (not shown), glued to the windshield 106, having a slot in which to place the display. As a further alternative, transparent (e.g., silicone compound) suction cups may be attached to display unit 101 to affix the display temporarily to the windshield.

FIG. 1B is an exemplary diagram showing a high-level view of one alternative embodiment of the present system, in which touch-pad box 102B is wirelessly coupled (per arrow 108B) with heads-up display 101 via display control box 112. In the present embodiment, touch-pad box 102B may be affixed, via temporary means, to an armrest or console 107 or other part of the vehicle in reasonable proximity to heads-up display 101. Display control box 112 is connected to heads-up display 101 via wiring 108C. In the embodiments described herein, audio transducer 103 may be either an earphone or a loudspeaker.

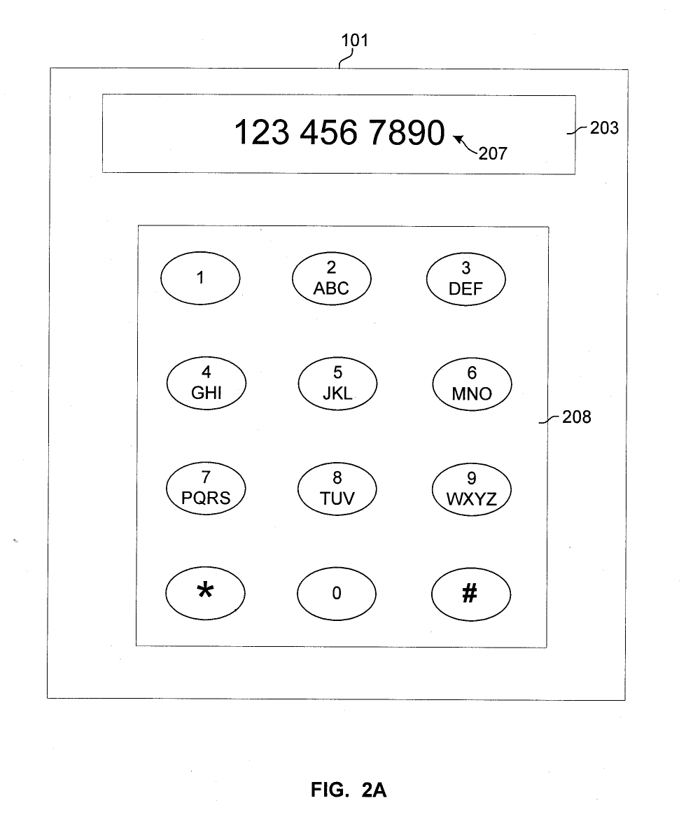

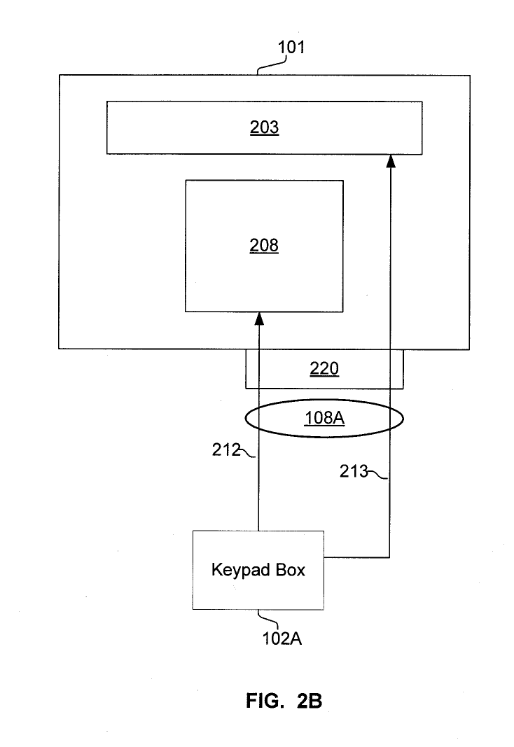

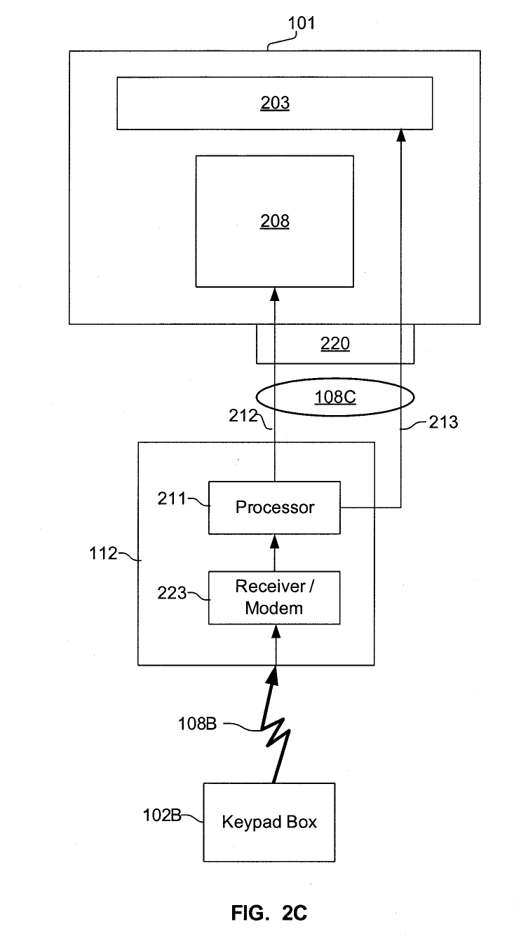

FIG. 2A is a diagram of an exemplary embodiment showing information displayable on a heads-up display 101 in accordance with the present system. As shown in FIG. 2A, heads-up display 101 includes sub-displays 203 and 208. Sub-display 203 typically displays either a caller ID (for an incoming call) or a phone number dialed on keypad 104. Sub-display 208 typically displays a representation of a telephone keypad, in which a particular digit, corresponding to a button pressed by a user on keypad 104, is displayed. It should be noted that sub-display 203 may be used to display information other than a caller ID or a user-dialed phone number 207.

FIG. 2B is a diagram of an exemplary embodiment showing a heads-up display 101 in accordance with the present system. As shown in FIG. 2B, heads-up display 101 is connected to touch-pad box 102A via wiring 108A, which comprises electrically-conducting media (e.g., wires or cables) 212 and 213. Wire/cable 212 is coupled to sub-display 208 and wire/cable 213 is coupled to sub-display 203 via connector port 220. Sub-displays 203 and 208 are driven by signals sent from keypad/display control box 102A, which is described in detail below.

FIG. 2C is a diagram of an exemplary alternative embodiment showing details of a wireless heads-up display assembly 101/112 in accordance with the present system. As shown in FIG. 2C, sub-displays 203 and 208 within heads-up display 101 are connected to, and driven by, processor 211 in display control box 112, via wiring 108C and connector port 220. Processor 211 receives and decodes signals received by receiver/modem 223, which itself receives control signals from keypad box 102B via a wireless protocol 108B, such as that employed by a television RF remote control device or garage door opener. More specific examples of wireless protocols that may be employed by the present system include the IEEE 802.11 family of standards known collectively as and Bluetooth (also known as the IEEE 802.15 standard) protocols.

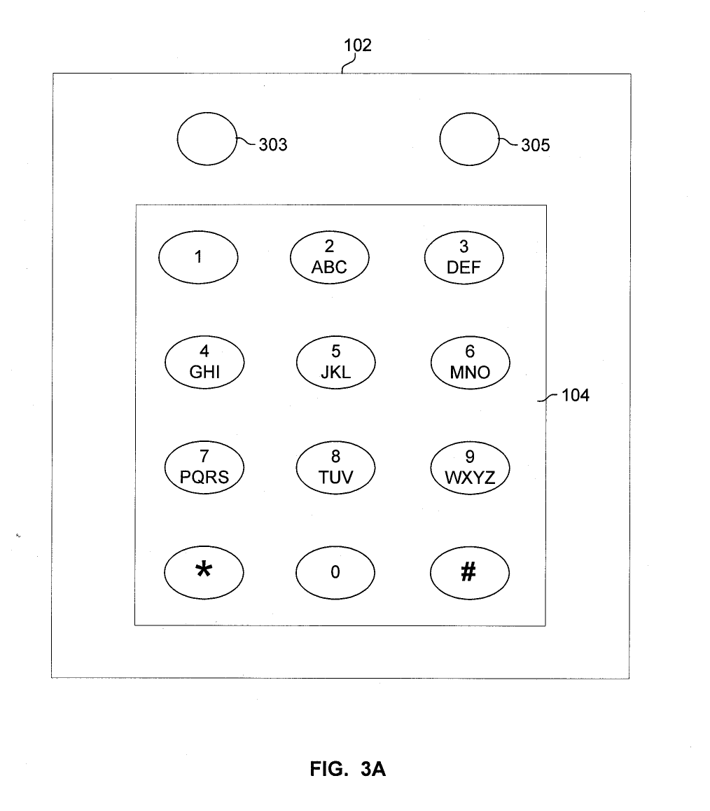

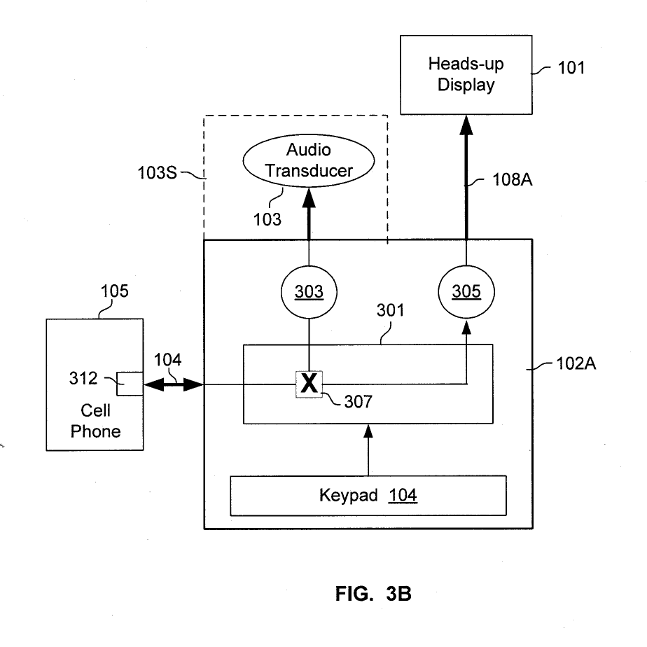

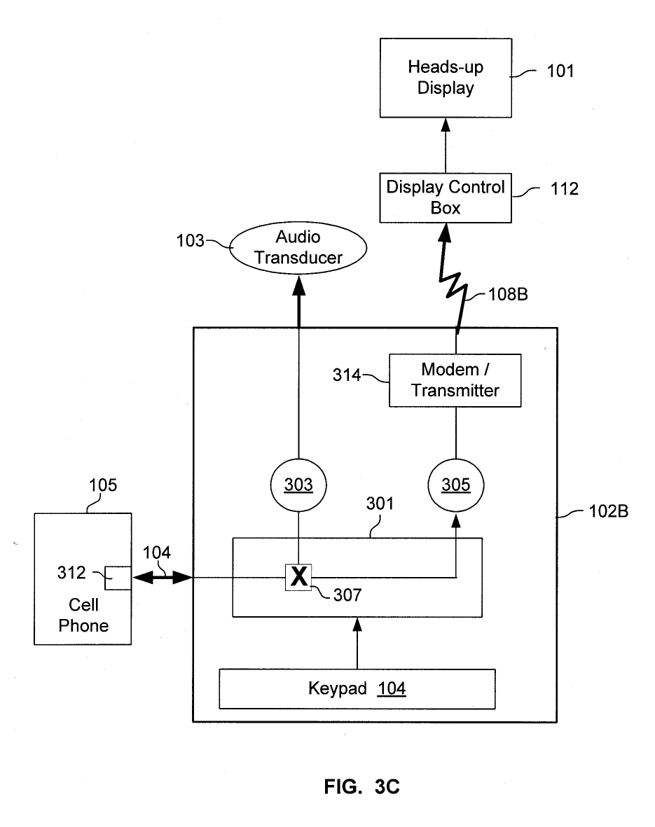

FIG. 3A is a diagram of an exemplary embodiment showing user input control mechanisms on the top side of keypad box 102A/102B. These user input control mechanisms include telephone keypad 104, and signal attenuators 303 and 305, which may be variable resistors or other signal amplitude control devices. Attenuator 303 is employed to control the volume of audio transducer 103, and attenuator 305 is used to control the brightness of heads-up display 101. Telephone keypad 104 may be a touch pad or other type of keypad suitable for providing user input of telephone numbers and other associated data to keypad box 102A or 102B. The user input control mechanisms shown on keypad box 102 in FIG. 3A are identical for each of the embodiments 102A and 102B, as depicted in FIGS. 3B and 3C, respectively.

FIG. 3B is a diagram of an exemplary embodiment showing details of a keypad box 102A using electrically-conducting media 108A to provide communication between the control box and heads-up display 101. As shown in FIG. 3B, processor 301 in keypad box 102A is connected to send and receive signals from an I/O port 312 on cellular telephone 105 via a cable or connector 104. Processor 301 also receives input from keypad 104. Processor 301 includes a software or firmware-controlled switch 307 for decoupling audio data from telephone number data received from cellular telephone 105, and directing the decoupled data to the appropriate signal attenuator 303/305. In an embodiment wherein a speaker 103S is used instead of an earphone, it is preferably housed within keypad box 102A, as indicated by dashed box 103S.

FIG. 3C is a diagram of an exemplary embodiment showing details of a keypad box 102B using a wireless protocol to provide communication between the keypad box 102B and heads-up display 101. The embodiment shown in FIG. 3C is similar to that of FIG. 3B, with the system of FIG. 3C having, in addition, modem/transmitter 314. Modem/transmitter 314 encodes signals received from processor 301, and sends the encoded signals to heads-up display 101 via a wireless protocol 108B, such as one of the protocols indicated above in the description of FIG. 2C.

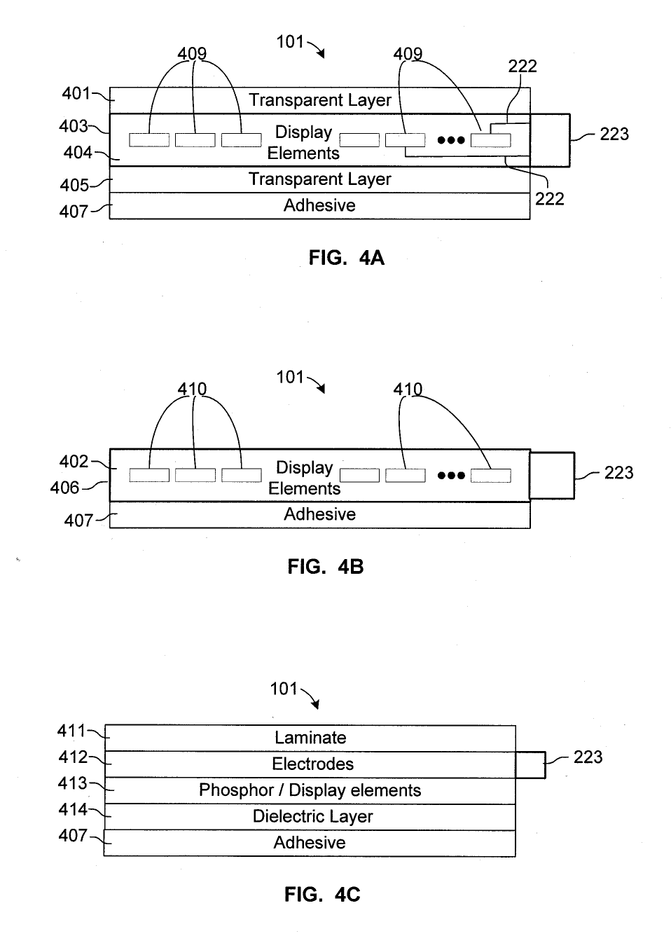

FIG. 4A is a diagram showing an exemplary heads-up display 101 in one embodiment of the present system. As shown in FIG. 4A, electroluminescent filaments (hereinafter “display elements”) 409 are placed between two transparent sheets 401/405 of plastic or other transparent, flexible material, such as SentryGlas film laminate, manufactured by 3M® Company. The term “transparent”, as used herein, is intended to include translucent material as well as essentially transparent material. Electrical connections for driving each of the display elements 409 are made via trace wiring 222 connected to port 223 on an edge of the display 101.

In an exemplary embodiment, the electroluminescent display, comprising layers 401/403/405 is sandwiched between the two layers of the transparent material using an adhesive 404 comprising a transparent filler substance, such as 3M® “ultra-clean laminating adhesive 501FL”.

In one embodiment, heads-up display 101 is removably affixed to a dashboard of an automobile or other vehicle using a clear adhesive layer 407, such as Invent It!™ brand clear decal material, which is applied to one side of the electroluminescent assembly.

FIG. 4B is a diagram showing exemplary construction of an alternative embodiment of the present system in which LCD (liquid crystal display) elements are employed as the electroluminescent light source for display 101. As shown in FIG. 4B, LCD elements 410 are embedded in a transparent material 402 to form display 406. As in the method described with respect to FIG. 4A, electrical connections for driving each of the display elements 409 are made via trace wiring (not shown) connected to port 223 on an edge of the display 101.

FIG. 4C is a diagram showing details of an exemplary construction of another alternative transparent electroluminescent display 101 using thick-film technology which is known in the art. As shown in FIG. 4C, display 101 includes a transparent substrate 411, transparent electrodes 412 deposited on the substrate, a phosphor layer 413, deposited on the transparent electrodes 412, which is illuminated when placed in an electric field. A dielectric layer 414 is then deposited on the phosphor layer 413. Phosphor layer 413 is deposited or etched in a pattern suitable for displaying alphanumeric characters. Electrical connections for driving each of the display elements in the phosphor are made via trace wiring (not shown) connected between electrodes 412 and port 223 on an edge of the display 101. A clear adhesive layer 407 is then applied to dielectric layer 414 to affix the display to a.

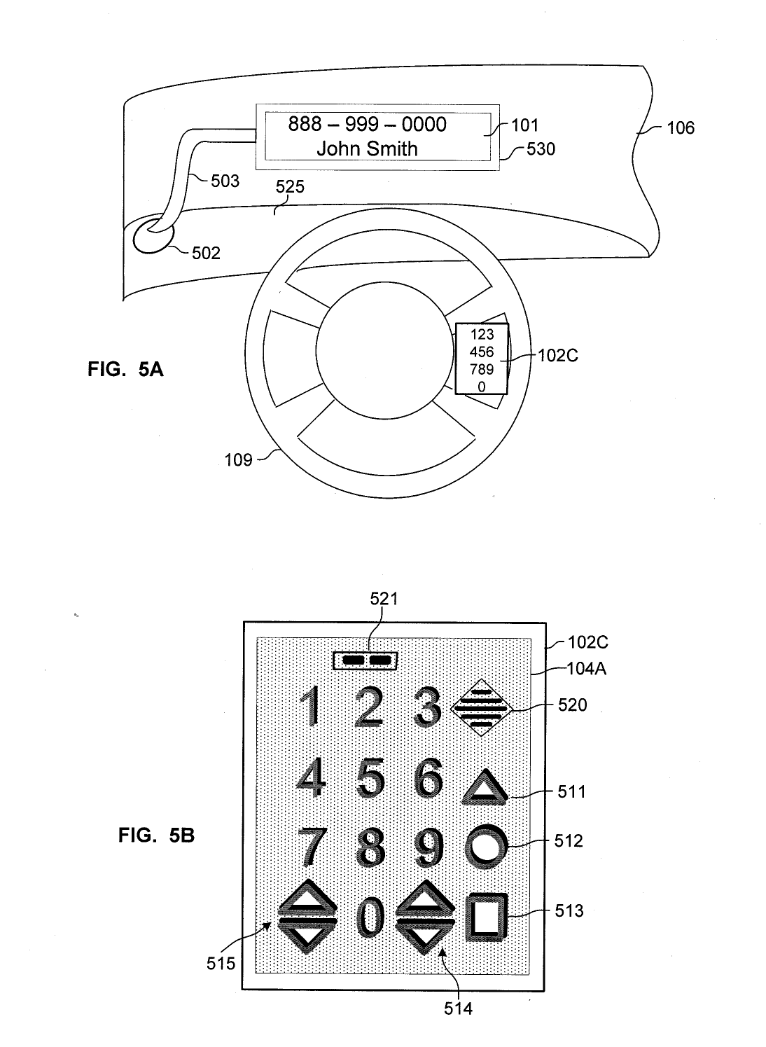

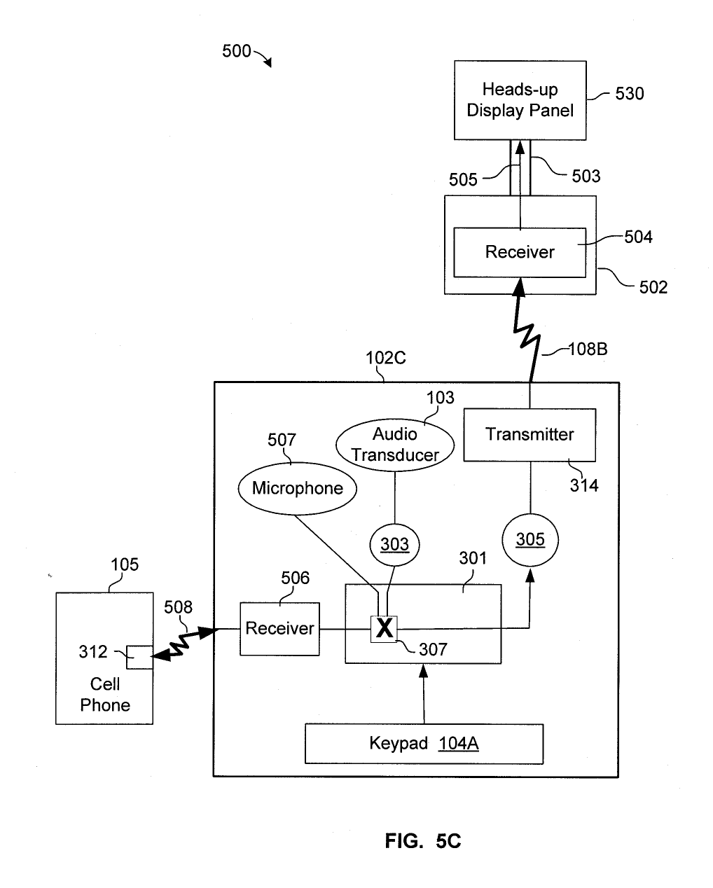

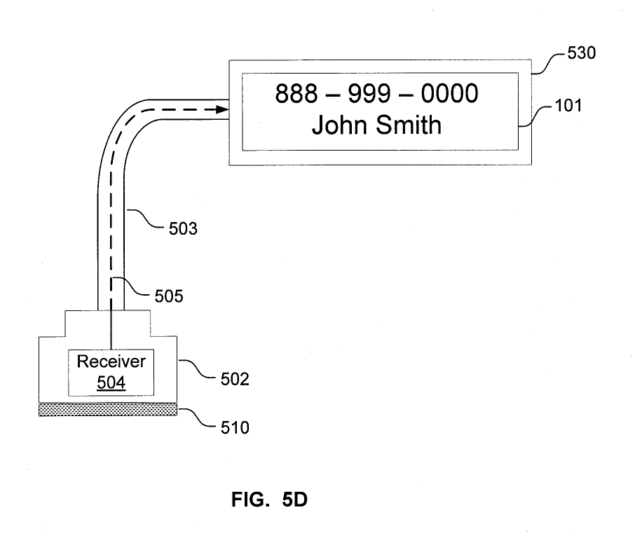

FIG. 5A is a diagram showing an exemplary configuration of modular heads-up display system 500, in an alternative embodiment. As shown in FIG. 5A, a keypad box 102C is preferably mounted on or between the spokes of the steering wheel 109 outside of the radius of the vehicle's air bag. Keypad box 102C includes a keypad 104A that has numbers (digits 0-9) raised in their actual configuration. Keypad box 102C contains a microphone 521 and audio transducer (e.g., a speaker) 520 with volume control and brightness control for the electro-luminescent numbers which appear on the heads-up display 101.

In an exemplary embodiment, display 101 (mounted in a transparent panel 530) is removably attached to the left side of the dashboard 525 via a ‘gooseneck’ 503 and a display mount 502. An adhesive mechanism 510 on the bottom of display mount 502 is used to attach the mount to the vehicle's dashboard, as explained in detail with respect to FIG. 5D, described below.

In the present embodiment, display 101 is affixed, via clear adhesive 407, to a rigid (or semi-rigid) sheet made from clear Lexan® polycarbonate, plexiglass or other clear acrylic plastic, or similar transparent material to form display panel 530. Display 101 displays the phone number entered by the user and also duplicates the caller ID info on the user's phone. The numbers displayed on display 101 are preferably large enough to be read without special glasses and are transparent when not in use.

FIG. 5B is a diagram showing details of an exemplary keypad 104A used in the embodiment of FIG. 5A. As shown in FIG. 5B, differently-shaped buttons on the keypad allow the vehicle's driver to turn the unit on (button 512), off (button 513), or clear the last digit of an incorrectly dialed number (button 511). Display brightness is controlled by buttons 515, and audio volume is controlled by buttons 514.

FIG. 5C is a diagram of an exemplary embodiment showing details of a keypad box 102C using a wireless protocol to provide communication between the cellular phone 105 and heads-up display 101. The embodiment shown in FIG. 5C is similar to that of FIG. 3C, with the system of FIG. 5C being, in addition, wireless coupled with cellular phone 105. As shown in FIG. 5C, processor 301 communicates with cellular phone 105 via receiver 506 and wireless link 508, using a wireless protocol such as, for example, IEEE 802.11 or Bluetooth (also known as IEEE 802.15 standard) protocol. Keypad box 102C is powered with one or more batteries (not shown).

Touch-pad box 102C is wirelessly coupled (per link 108B) with heads-up display 101 via receiver 504 in display mount 502. Receiver 504 may include a processor (not shown) for driving display 101. One or more batteries (not shown) are housed in the display mount for powering receiver 504 and display 101. Keypad box 102C is similar to is similar to keypad box 102B, and further includes a microphone 507, and a receiver 506 for communication with cellular phone 105.

FIG. 5D is a diagram of an embodiment showing exemplary methods for mounting the display on vehicle dashboard 525. Display panel 530 is attached to display mount 502 via a gooseneck 503 which is preferably constructed from clear or transparent plastic material which is coiled in a helical fashion for flexibility. The gooseneck may be made from polyurethane, vinyl, polyethylene, polypropylene, or nylon approximately ¼″ in diameter. Alternatively, gooseneck 503 may be constructed from metal or plastic tubing, or from a helically coiled tubular configuration such as that used with gooseneck lamps. Attachment of display mount 502 to dashboard 525 is implemented by the use of an adhesive mechanism on the bottom of display mount 502, such as a suction cup, either the hook or the loop part of a removable hook-and-loop tape such as Velcro®, or other non-permanent means 510. Wiring 505, which is channeled through gooseneck 503, connects the output of receiver 504 to display 101.

Certain changes may be made in the above methods and systems without departing from the scope of that which is described herein. It is to be noted that all matter contained in the above description or shown in the accompanying drawings is to be interpreted as illustrative and not in a limiting sense. For example, the system shown in the accompanying drawings may include different components than those shown. The following claims are intended to cover all generic and specific features described herein, as well as all statements of the scope of the present method, system and structure, which, as a matter of language, might be said to fall there between.

What is claimed is:

1. A portable heads-up display system for a cellular telephone comprising:
a transparent display panel including a display for displaying information sent and received via the telephone;
a display mount removably attachable to a dashboard of a vehicle;
a flexible gooseneck connecting the display panel and the display mount; and
a keypad box, affixable to a steering wheel of the vehicle, including a keypad for entering telephone numbers to be dialed, wirelessly coupled between the telephone and the display.

2. The system of claim 1, wherein the display mount includes a suction cup for attaching the mount to the dashboard.

3. The system of claim 1, wherein the display mount includes one part of a hook-and-loop tape for attaching the mount to the dashboard.

4. The portable heads-up display of claim 1, wherein the information includes a phone number dialed on the keypad and a caller ID for an incoming call.

5. The system of claim 1, wherein the display mount includes a receiver for receiving the information from the keypad box.

6. The system of claim 1, wherein the keypad box is also connected to an audio transducer for annunciating audio information received by the cellular telephone.

7. The system of claim 1, further including:
a first receiver for receiving information from the cellular phone;
a transmitter, located in the keypad box, for sending the information to the display panel via a wireless protocol;
a second receiver, located separately from the keypad box, for receiving the information from the transmitter and sending the information to the display panel;
wherein the information includes a phone number dialed on the keypad.

8. The system display of claim 1, wherein the keypad includes a plurality of keys having numbers that are raised in their actual configuration.

9. The system of claim 1, wherein the gooseneck is adjustable so that the display is not in contact with the windshield of the vehicle.

10. A modular portable heads-up display system for a cellular telephone comprising:
a transparent display panel including a display for displaying information sent and received via the telephone;
a keypad box, wirelessly coupled between the telephone and the display, that duplicates features of the telephone including a microphone, an audio transducer, and a keypad for entering telephone numbers;
a flexible gooseneck having a first end thereof attached to the display panel for support thereof; and
a display mount, attached to a second end of the gooseneck, removably attachable to a dashboard of a vehicle; wherein the display mount includes a receiver for receiving the information from the keypad box.

11. The system of claim 10, wherein the information sent via the cellular telephone includes a phone number dialed on the keypad and a caller ID.

12. A portable heads-up display system for a cellular telephone comprising:
a modular portable heads-up display system for a cellular telephone comprising:
a transparent display panel including a display for displaying information sent and received via the telephone;
means, wirelessly coupled between the telephone and the display, for duplicating features of the telephone including a microphone, an audio transducer, and a keypad for entering telephone numbers;
flexible support means having a first end thereof attached to the display panel; and
mounting means, attached to a second end of the flexible support means, for removably attaching the display panel to a dashboard of a vehicle.

13. The system of claim 12, wherein the mounting means includes a suction cup for attaching the mount to the dashboard.

14. The system of claim 12, wherein the mounting means includes one part of a hook-and-loop tape for attaching the mount to the dashboard.

15. The system of claim 12, wherein the mounting means includes a receiver for receiving the information from the keypad box.
